(19) United States
(12) Patent Application Publication
(10) Pub. No.: US 2010/0050407 A1
(43) Pub. Date: Mar. 4, 2010

(54) Method of Repairing Tong Jaw

(76) Inventors: David A. Buck, Breaux Bridge, LA (US); Daniel S. Bangert, Broussard, LA (US); Rizal Masingkan, New Iberia, LA (US); Michael Coates, Maurice, LA (US)

Correspondence Address: JONES, WALKER, WAECHTER, POITEVENT, CARRERE;& DENEGRE, L.L.P., 5TH FLOOR, FOUR UNITED PLAZA, 8555 UNITED PLAZA BOULEVARD, BATON ROUGE, LA, 70809, US

(21) Appl. No.: 12/200,070

(22) Filed: Aug. 28, 2008

(51) Int. Cl. B23P 6/00

(52) U.S. Cl. 29/402.12

(57) ABSTRACT

A method for repairing a damaged or corroded tong jaw having a jaw root and an original seating component. The method includes the steps of: (a) machining away corroded or damaged portions of the original seating component; (b) machining into a non-damaged portion of the original seating component and/or jaw root, thereby forming a machined base configured to receive a new seating component, the new seating component including a feature adapted for engaging the machined base. The new seating component is then connected onto the machined base.

### FIELD OF INVENTION

The invention relates to wrenches or tongs use for making-up and breaking-out threaded connections on drill pipe and other tubular members employed in the oil and gas industry. More specifically, the invention relates to repairing the jaw component of such tongs.

### BACKGROUND OF INVENTION

Many different tong devices are used in the oil and gas industry to makeup (connect together) and breakout (disconnect) the threaded joints of tubular members (e.g. casing, tubing, pipe, or drill pipe) employed in the oil and gas exploration and production industry. One such device is produced by National Oilwell VARCO under the designations ST-80 or ST-80C (see also U.S. Pat. No. 7,188,547) and combines a torque wrench and a spinning wrench to connect and disconnect tubular members.

The torque wrench includes a jaw member which closes on and grips the tubular member. Typically, the jaw member will have a removable die insert which provides the surface actually contacting the tubular. The die inserts will have some type of gripping surface (e.g., a series of grooves, a knurled tooth pattern, etc.) on the side designed to engage the tubular and a feature for connecting to the jaw member on the opposite side (e.g., grooves, a dovetail shape, a key and keyway arrangement, or a combination thereof).

Often the jaw member and the die inserts are of dissimilar metals, for example the body of the jaw member could be constructed of a AISI 4XXX series alloy steel while the die has been made from other alloys which are carburized or heat treated to have different characteristics. When sea water, drilling mud, or other corrosive fluids become trapped between the jaw member and the die insert, combined with repeated working of this contact area (or interface) when the tong is in use, significant corrosion can occur at this interface. If the corrosion becomes sufficiently advanced, the die insert does not properly maintain its precise position on the jaw member and the tong must be taken out of service for repaired. Certain tools use relatively fine grooves to transfer the tangential load between the jaw and die, making these tools more sensitive to corrosion failure than alternate coarser, more robust connection systems. Currently, the typical repair method is to replace the entire jaw member, a large and expensive component. It would be a significant advantage in the art if the jaw member could be repaired without being completely replaced.

### SUMMARY OF INVENTION

One embodiment of the present invention includes a method for repairing a damaged or corroded tong jaw having a jaw root and an original seating component. This embodiment includes the steps of: (a) machining away corroded or damaged portions of the original seating component; (b) machining into a non-damaged portion of the original seating component and/or jaw root, thereby forming a machined base configured to receive a new seating component. In this embodiment, the new seating component includes a feature adapted for engaging the machined base. Then the new seating component is connected onto the machined base.

### BRIEF DESCRIPTION OF DRAWINGS

FIG. 1 is a view of a prior art tong jaw with details of the die and original seating surface.

FIG. 2 is a view of the prior art tong jaw with a damaged/corroded interface between the die and original seating surface.

FIG. 3 is a view of the machined base after the completion of the machining.

FIG. 4 is a view of the machined base, new seating component, and die.

FIG. 5 is a view of the new seating component and a detail showing the cavity for the machined base.

FIG. 6 is a view of the tong jaw after the repair has been completed.

### DETAILED DESCRIPTION OF PREFERRED EMBODIMENTS

One embodiment of the invention may be used to repair the jaws of tongs such as the model ST-80 sold by National Oilfield Varco. However, the method may be applicable to other tong jaws and gripping apparatuses and should not be considered as limited to only the ST-80 product line.

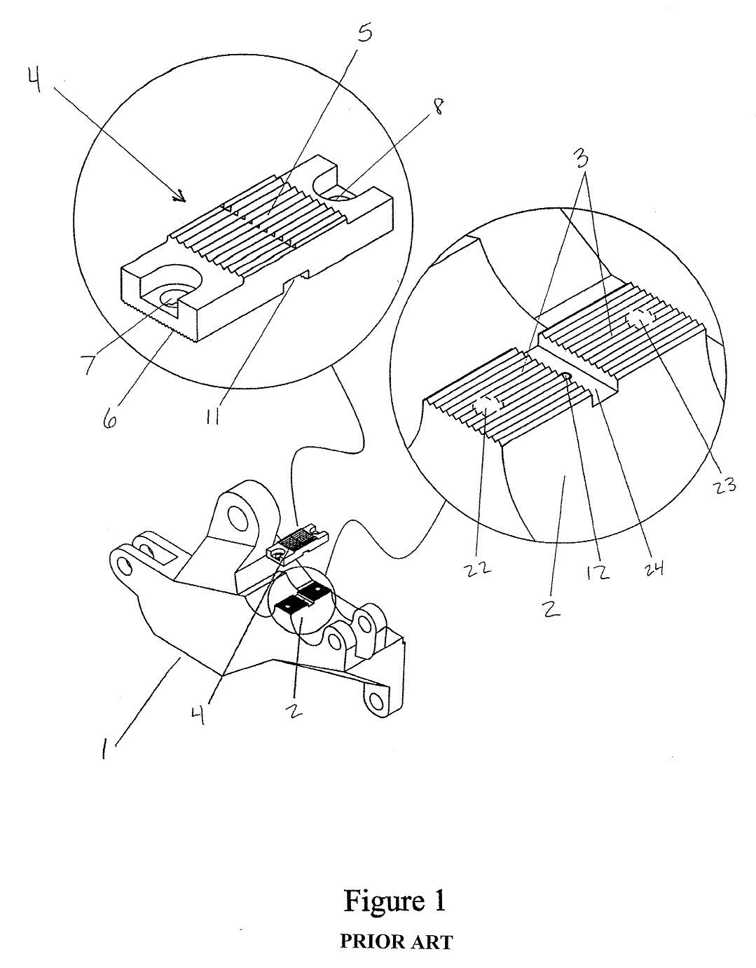

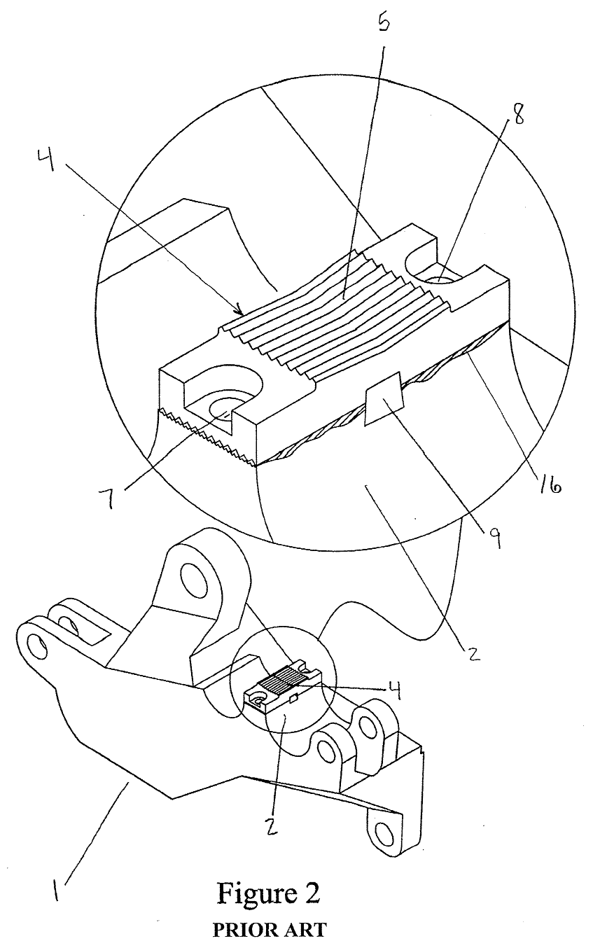

FIG. 1 shows a common embodiment of a prior art tong jaw 1 with enlarged details of a die 4 and original seating surface 3. The original seating surface 3 is an extension of the jaw root 2, i.e., a portion of the tong jaw 1 below the original seating surface 3. In the illustrated embodiment, the top of the original seating surface 3 comprises a series of ridges and grooves. The top profile 5 of a die 4 grips an object, usually a section of drill pipe or another tubular member. The bottom profile 6 of a die 4 engages the original seating surface 3 and provides support to the die 4. Although largely hidden from view in the Figures, it will be understood that bottom profile 6 has a series of ridges and grooves corresponding with those on original seating surface 3. The holes or bores 7 and 8 on the die 4 correspond to holes 22 and 23 on the original seating surface 3. The holes 7, 8, 22 and 23 are aligned and screws (or other connectors) will engage the holes and secure die 4 to the original seating surface 3. As alluded to above and suggested in FIG. 2, a layer of corrosion or similar damage may occur at the interface 16 of die 4 with original seating surface 3.

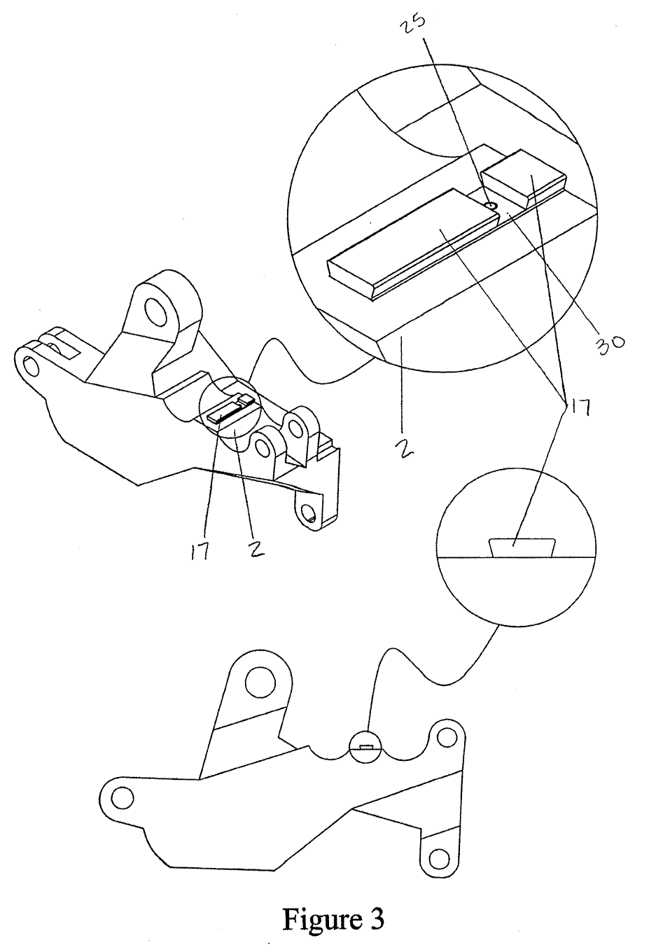

In one embodiment of the repair process, the damaged or corroded portions of the original seating surface 3 is first removed by machining away the damaged portion or removing it by any other suitable process. As used herein, “machining” means any conventional or future developed method of forming features on metal, including as nonlimiting examples, a vertical mill, a horizontal machining operation, or electrical discharge machining (EDM). In certain embodiments, the initial removal of the damaged portion could be accomplished with low precision grinding. Next, the underlying portions of the non-damaged original seating surface 3 and/or jaw root 2 are machined to create a shaped machined base 17. FIG. 3 shows one example of a machined base 17 following a machining of the original seating surface 3. One detail shows the machined base 17 from a side view, presenting one preferred dovetailed shape of the machined base 17. The machined base 17 has a key slot 30 and a bore 25 within the key slot 30. In this embodiment, the machined base 17 spans only a portion of the jaw root 2, with one end even with a first side of jaw root 2 and the other end some distance from the opposite side of jaw root 2.

Naturally, the invention is not limited to the dovetail configuration shown in the figures and many other configurations could be used in the alternative. Non-limiting examples of these alternatives include splines such as in U.S. Pat. No. 4,576,067 (incorporated by reference herein), a machined key-way and matching key, or a series of pins located in holes bored into the jaw. The dovetail configuration may be advantageous in certain instances as it retains the component in the radial and tangential directions. The alternate configurations mentioned above will resist the tangential loads but require an alternate method such as fasteners to provide radial retention. Additionally, the dovetail configuration can withstand very high loads when compared to many alternative methods.

An alternate repair method could employ low precision grinding, followed by welding a replacement slab of material in place or building up the area using multiple passes of weld filler materials. Ultimately, the imperfectly repaired area would be machined to the geometry necessary to accept the gripping die. The use of welding with alloy steels has many potential disadvantages including cracking in the weld heat affected zone and is likely to require the entire part be subject to a heat treating process to return the heat affected zone to an acceptable hardness level.

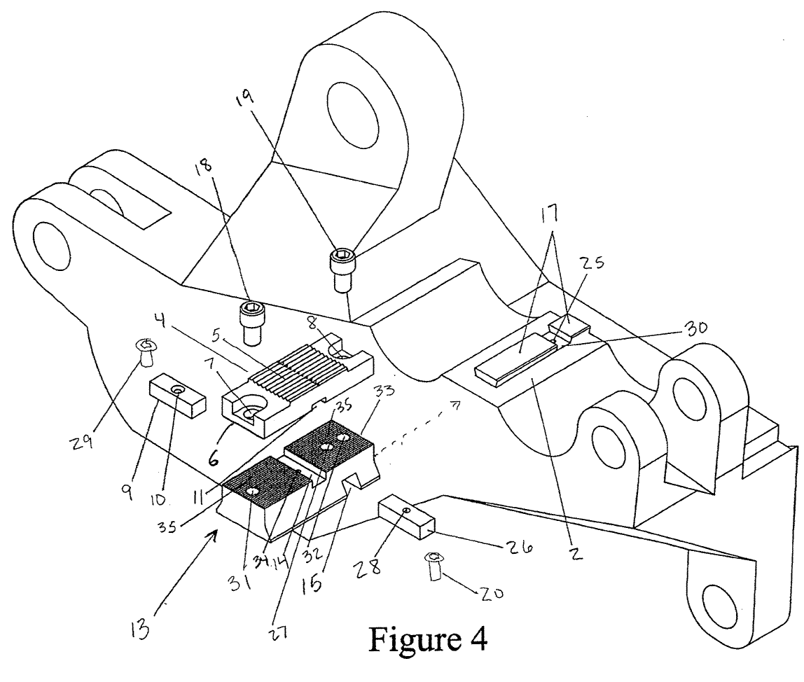

FIG. 4 shows the machined base 17 with one embodiment of the new seating component 13. In this example of new seating component 13, the seating component will include a corrosion resistant surface 35 which reduces sensitivity to corrosion damage at the interface 16 between the die 4 and the new seating component 13. In the embodiment shown, the corrosion resistant surface is created simply by forming the entire (or substantially the entire) component from a corrosion resistant material. In certain embodiments, the new seating component 13 could be constructed of a higher strength material than is used in the original jaw material (e.g., the jaw root) in order to lessen the possibility of mechanical damage to the small ridges when the seating component resists loads applied by the case hardened dies. A still further embodiment would employ a die whose hardness is greater than the new seating component. In one example of this embodiment, the jaw has a hardness of about 37 HRC, the new seating component has a hardness of about 44 HRC, and the carburized die has a case hardness of about 58 to about 62 HRC. Naturally, the hardness could differ substantially from these values and still fall within the scope of the invention. Nor is it critical that the hardness of the die exceed that of the new seating component. For example, an alternate embodiment could employ a new seating component which has been subject to hardening process giving it a greater hardness than the die, e.g., a nitriding surface hardening process which results in a very thin (less than about 0.0005″) surface layer with an equivalent surface hardness of about 70 HRC. Where an article (e.g., jaw root, seating component, or die) is described as having a certain hardness, it means at least a thin surface layer of the article has that certain hardness. However, that surface layer may extend to any depth of the article or even the entire volume of the article may have that hardness.

Nonlimiting examples of corrosion resistant materials include heat treated stainless steels, nitride carbon steels, or metals such as titanium. While non-metal materials typically will be less suited for constructing the new seating component, some non-metal materials may be suitable for handling loads encountered in this class of gripping tools. Non-limiting examples could include reinforced materials employing carbon fiber, nano-materials, and other super strength class composites. Any other method of creating a corrosion resistant surface on the new seating component is within the scope of the present invention. For example, forming a new seating component of a less corrosion resistant material and then plating it with a more corrosion resistant material. The corrosion resistant material could be limited to just the surface in contact with die 4, but more preferably covers most or all of new seating component 13.

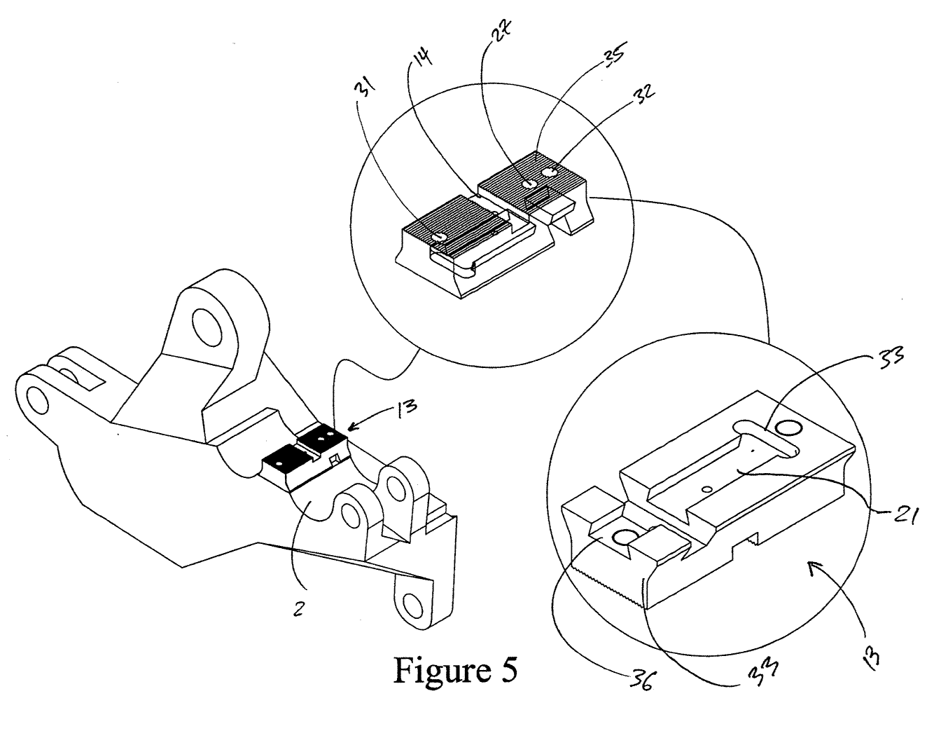

FIG. 5 illustrates how the new seating component 13 contains a feature such as cavity 21 into which the machined base 17 can slide. The cavity 21 includes an opening 36 on one side to allow the new seating component 13 to slide onto the machined base 17. The cavity 21 is closed on the opposite side 33 of the new seating component 13 to act as a stop when new seating component 13 slides onto machined base 17. Following the completion of the machining, new seating component 13 is connected to the machined base 17. The opening 36 to the cavity 21 is located on the leading face 33 of the new seating component 13. The leading face 33 is the side of the new seating component 13 that engages the machined base 17 first. The opening 36 corresponds to the shape of the machined base 17 and is dovetailed in the preferred embodiment illustrated. As suggested in FIG. 4, the opening 36 will face the side of the machined base 17 that does not meet the side of the jaw root 2. The new seating component 13 should slide into the opening 36 and rest flush with both ends of the jaw root (see FIG. 5). The hole 25 on the machined base 17 should line up with the hole 27 on the surface of the new seating component 13. A key 26 is then inserted into the key slot 30 between the machined base 17 and the new seating component 13. The hole 28 on the key 26 should line up with the hole 25 on the machined base and the hole 27 on the surface of the new seating component 13. A screw then connects the new seating component 13, the key, and the machined base 17 securely to the jaw root. The key provides support to the new seating component 13 and also assists in preventing the new seating component 13 from being displaced laterally relative to (e.g., sliding off of) the machined base 17.

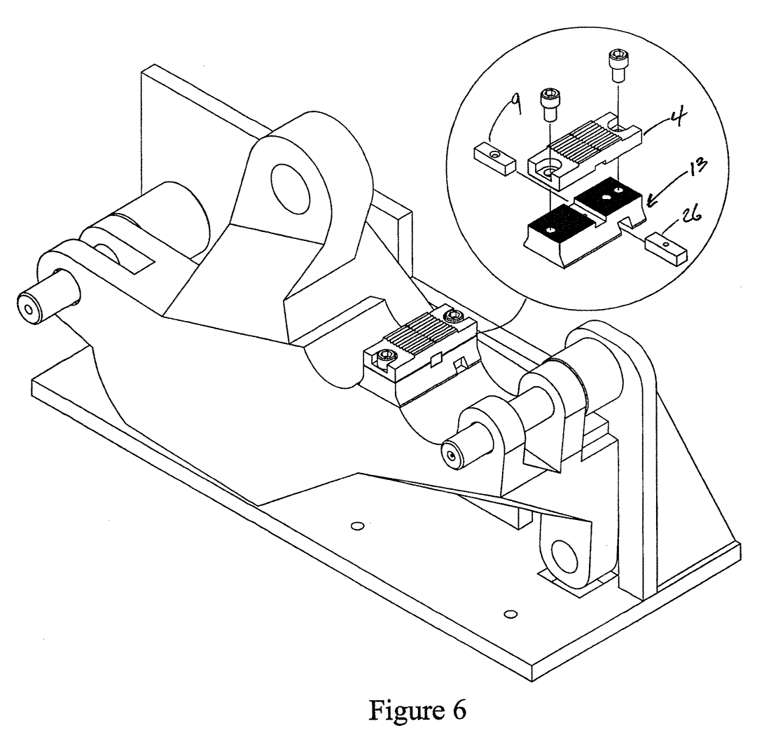

After securing the new seating component 13 to the machined base 17, the next step is to fasten a key 9 (FIG. 4) to the upper key slot 14 on the new seating component 13. A hole 10 in the key 9 lines up with a hole 34 in the upper key slot 14. A screw 29 connects the key 9 to the upper key slot 14 on the new seating component 13 through the hole 10. A die 4 with a lower key slot 11 on its lower profile 6 then rests on the key 9 and new seating component 13. The holes 7 and 8 on the die will align with the holes 31 and 32 located on the surface of the new seating component 13. Screws 18 and 19 then connect the die 4 to the new seating component 13 through the holes 7, 8, 31, and 32. Upon completion of the repair, this embodiment of tong jaw 1 will have a configuration such as seen in FIG. 6.

Although the figures illustrate one particular embodiment, it will be understood that the invention includes all obvious variation and modifications. For example, while machined base 17 is shown as having a dovetail shape, machined base 17 could be configured to receive a new seating component 13 by being formed into any shape that provides a “tongue and groove” type engagement. In a similar manner, the bottom of new seating component 13 could include any mating feature. Nor does machined base 17 need to form the “tongue,” but could form the “groove” by having a cavity machined therein. In this embodiment, the feature on new seating component 13 would be tongue portion which engages the groove or cavity on machined based 17. Further, the invention is not even limited to a tongue and groove configuration, but could be any manner of securely attaching a new seating component to a jaw that has any type of machined base. And while certain embodiments utilize a machined seating component 13, other embodiments could utilize a cast seating component 13 or a reinforced composite material seating component. All such variations and modifications are intended to come within the scope of the following claims.

We claim:

1. A method for repairing a damaged or corroded tong jaw comprising a jaw root and an original seating component, said method comprising the steps of:
a. removing corroded or damaged portions of said original seating component;
b. machining into a non-damaged portion of said original seating component and/or jaw root, forming a machined base configured to receive a new seating component, said new seating component including a feature adapted for engaging said machined base;
c. connecting said new seating component onto said machined base.

2. A method according to claim 1, wherein said feature on said new seating component comprises a cavity machined into a body of said new seating component.

3. A method according to claim 1, wherein said machined base comprises a substantially rectangular shape.

4. A method according to claim 3, wherein said machined base comprises a dovetail configuration.

5. A method according to claim 1, wherein said milled base comprises a keyway to assist in securing said new seating component thereto.

6. A method according to claim 1, wherein a die is connected to said new seating component.

7. A method according to claim 1, wherein said original seating component comprises
a. an original seating surface
b. a plurality of connector bores and
c. a key slot.

8. A method according claim 1, wherein said new seating component comprises a corrosion resistant surface.

9. A method according claim 8, wherein said new seating component is formed at least substantially of a corrosion resistant material.

10. A method according claim 1, wherein, said new seating component further comprising at least
a. two key slots
b. holes within said key slots
c. a hole for connecting the die
d. a hole connecting said key slot with the new seating component
e. a seating surface for a die

11. A method of claim 2, wherein said cavity within the new seating component comprises a dovetail shape which engages a corresponding feature on said machined base.

12. A method according to claim 11, wherein a key engages said new seating component and said machined base.

13. A method of claim 12, wherein a screw fixes said new seating component to said machined base.

14. A method of claim 6, wherein said die comprises:
a. a top profile
b. a bottom profile
c. a key slot
d. and at least one hole, wherein at least one screw engages the die to at least one hole of the new seating component.

15. A method of claim 1, wherein said new seating component comprises a top profile mating with a bottom profile of a die.

16. A method of claim 15, wherein at least one screw and a key secures said die to said new seating component.

17. A method for repairing a damaged or corroded tong jaw comprising a jaw root and an original seating component, said method comprising the steps of:
a. removing away corroded or damaged portions of said original seating component;
b. machining into a non-damaged portion of said jaw root and/or original seating component, thereby forming a machined base configured to receive a new seating component, said new seating component including:
i. a feature adapted for engaging said machined base;
ii. a corrosion resistant surface;
iii. a key or keyway formed therein; and
c. connecting said new seating component onto said machined base.

18. A method according claim 17, wherein said new seating component has a hardness greater than said jaw root.

19. A method according to claim 18, further comprising connecting a die to said new seating component wherein said die has a hardness greater than said new seating component.

20. A method of claim 18, further comprising connecting a die to said new seating component wherein said new seating component has a hardness greater than said die.
